(19) United States
(12) Patent Application Publication
(10) Pub. No.: US 2024/0342959 A1
(43) Pub. Date: Oct. 17, 2024

(54) METHOD FOR PRODUCING A PLASTIC GRANULATE, AND USE OF THE GRANULATE

(71) Applicant: ALPLA WERKE ALWIN LEHNER GMBH & CO. KG, Hard (AT)

(72) Inventors: Andreas Weber, Thüringen (AT); Patrik Karrer, Owingen (DE); Wibke Becker, Bregenz (AT)

(21) Appl. No.: 18/683,234

(22) PCT Filed: Aug. 9, 2022
(86) PCT No.: PCT/EP2022/072357

§ 371 Date: Feb. 12, 2024

(30) Foreign Application Priority Data
Aug. 11, 2021 (CH) 70154/2021

(51) Int. Cl. B29B 9/12; B29B 9/06; B29B 9/16; B29B 13/00; B29B 13/04; B29B 13/06; B29B 13/10; B29B 17/02; B29D 22/00; B29K 67/00; B29K 105/00; B29K 105/26; C08J 11/06

(52) U.S. Cl. CPC B29B 9/12; B29B 9/06; B29B 9/16; B29B 13/04; B29B 13/065; B29B 13/10; B29B 17/02; B29D 22/003; C08J 11/06; B29B 9/065; B29B 2009/165; B29B 2013/002; B29K 2067/003; B29K 2105/0094; B29K 2105/26; B29K 2995/0022; B29K 2995/0082; B29K 2995/0089; C08J 2367/02

(57) ABSTRACT

A method for the production of granulate suitable for the production of extrusion-blow-molded hollow bodies, comprising:
sorting by type, washing, and comminuting PET articles originating from a post-consumer collection of plastic packaging,
removing contaminants from the PET articles,
premixing PET material from various types of the sorted PET articles so that a Trouton ratio of mixed PET material at a shear rate of 50 to 200 s⁻¹ is less than 4,
drying the PET material,
melting the dried PET material,
pressing the PET material through a filter,
dividing the PET material into individual melt streams,
cooling and solidifying the melt streams in a water bath and separating the solidified melt flows into pellets, wherein the pellets have an intrinsic viscosity of 0.5 to 0.75 dl/g,
crystallizing the pellets, and
drying and condensing the crystallized pellets in a solid-phase polycondensation reactor until they reach an intrinsic viscosity of 1.0 to 1.7 dl/g.

### CROSS-REFERENCE TO RELATED APPLICATIONS

This application is a national phase entry under 37 U.S.C § 371 of PCT/EP2022/072357 filed Aug. 9, 2022, which claims priority to Swiss Patent Application No. 70154/2021 filed Aug. 11, 2021, the entirety of each of which is incorporated by this reference.

### FIELD OF THE INVENTION

The invention relates to a method for the production of a plastic granulate suitable for the production of extrusion-blow-molded hollow bodies of recycled Polyethylene terephthalate (PET) with high impact strength and high gloss, and to an extrusion-blow-molded hollow body of the same type.

### Prior Art

Publications by Axtell¹, Dhavalikar² and Kruse³ are known from the prior art in the field of rheological properties of PET for extrusion blow-molding. It is described there that branched PET types have more suitable rheological properties for extrusion blow-molding than do linear PET types. Kruse points out the manifold possibilities for controlling the rheological properties of PET via the production of long-chain branches by means of branching additives. He hypothesizes that branched structures of high molecular weight would be advantageous with respect to several properties including crack growth resistance in structural members. ¹ Axtell, F. H.: A study of the flow properties and processability of thermoplastic polyesters, Dissertation, Loughborough University, 1987² Dhavalikar R. D.: Reactive melt modification of polyethylene terephthalate; Dissertation, Faculty of New Jersey Institute of Technology, 2003³ Kruse, M.: From Linear to Long-Chain Branches Poly (ethylene terephthalate)—Reactive Extrusion, Rheology and Molecular Characterization, in Schriftenreihe Kunststoffforschung (Wagner M., eds.), 81, Universitätsverlag der TU Berlin, 2017, ISBN 978-3-7983-2892-1

In reality, for the production of extrusion-blow-molded containers, sufficient melt elasticity of the PET is a necessary condition for being able to mold the container at all. However, this does not yet ensure whether other application-relevant parameters can meet the application-specific requirements for an extrusion-blow-molded container. One of these requirements is sufficient impact strength of the material with regard to the drop test. A bottle that drops to the ground from a height typical of the application and bursts does not meet the condition that the contents are to remain inside the bottle. This is a particularly important aspect for larger containers, since the ratio of packaging material to contents is typically lower than for very small containers (for example, in the 25 ml range).

WO2018/127431A1 discloses a method for the production of a PET regrind (note: recycled PET (rPET) for extrusion blow-molding) with high intrinsic viscosity, and a method for its production. This material, with an intrinsic viscosity of at least 0.95 dl/g and more advantageously between 1.1 dl/g and 1.7 dl/g, is suitable for the production of extrusion-blow-molded containers. The method disclosed therein uses solid-phase polycondensation to condense its feedstock into the PET product with the desired intrinsic viscosity. High intrinsic viscosity is necessary for linear PET types to have sufficient melt stiffness for the production of extrusion-blow-molded bottles, especially of large capacities. The larger the container, the higher the parison stiffness required, which correlates with the intrinsic viscosity. However, considerations of impact strength do not play a role in this.

WO2015/065994 discloses a branched copolyester with which the addition of pyrogenic SiO2 (common name: fumed silica) reduces (improves) the reduction in impact strength over time. The branched copolyesters disclosed in this publication have intrinsic viscosities in the range of 1.0 to 1.1 dl/g.

However, none of the previously cited publications deals with setting levers for the level of impact strength as a function of material parameters of PET and thus the drop height of an extrusion-blow-molded bottle that can be achieved in the drop test. rPET in particular plays no role in the cited publications in this regard. Moreover, no studies are known that deal with the real behavior of PET in the form of an extrusion-blow-molded bottle in a drop test and the drop height that can be achieved in it.

A further circumstance worth considering is the fact that plastics used in the packaging sector should or must be recyclable. On the one hand, this is defined by regulatory requirements (see Directive (EU) 2019/904 of the European Parliament, the so-called “Directive on single-use plastics”), and there are corresponding specifications in various guidelines on design for recycling (see Recyclass Guidelines⁴ or Guidelines of the Association of Plastic Recyclers (APR)⁵). In addition, various players in the packaging sector have committed themselves to using appropriate proportions of recycled material in their packaging (see the European Plastics Pact⁶ and U.S. Plastics Pact⁷). This necessarily requires that potential recycled materials are not contaminated or their properties are not changed in a detrimental way. Otherwise, such materials are typically downcycled or thermally recycled, or must be fed to chemical recycling, which is much more complex than mechanical recycling (material recycling), where the materials are broken down into their building blocks, cleaned and rebuilt into polymers that are suitable for use. If, for example, the elasticity of PET is significantly increased by changes in the molecular architecture (this is typically done by inserting branches), the same materials, when a parison for stretch blow-molding consisting of these materials is injected and the same parison is stretch-blown, will not behave correspondingly, as the linear PET materials commonly used in this segment would. Accordingly, such branched materials should no longer be recycled as materials, since there is a risk that if such materials are recycled into materials for the injection-molding of parisons, processing properties will change negatively during stretch blow-molding of the parisons. Moreover, in the case of non-uniform temporal quantity accumulation of such modified materials in the material flow from post-consumer collection, the bottom line is that the elastic properties of the parisons during stretch blow-molding will vary and undesirable process and associated product quality variations will result. ⁴ https://recyclass.eu/de/uber-recyclass/richtlinien-fuer-recyclingorientiertes-produktdesign/ retrieved on Jul. 13, 2021⁵ https://plasticsrecycling.org/apr-design-guide; retrieved on Jul. 13, 2021⁶ https://europeanplasticspact.org/; retrieved on Jul. 13, 2021⁷ https://usplasticspact.org/; retrieved on Jul. 13, 2021

In this connection, the finding that greatly branched PET types may well already be present in the market for virgin PET (vPET), and therefore in items in post-consumer collection, is problematic. Cf. EP2596044B1. The substances used in the same publication are well known in the scientific literature for causing branching in PET (EP0639612A1, Härth and Dornhöfer 2020⁸, Incarnato et al. 2000⁹,Dhavalikar 2003¹⁰). That branched types are indeed on the market is suggested by measurements on a vPET type from Asia, which has a Trouton ratio of 4.8 at 124 s-1 with an IV of 1.19 dl/g, which is atypical of a linear PET type. Such types should be excluded from the production of recycled material that is intended for use in the injection-molding of parisons for stretch blow-molding. Today, typical materials for bottle-to-bottle recycling of PET within the framework of the injection-molding of parisons for the stretch blow-molding of PET bottle types have a Trouton ratio in the shear rate range from 50 to 200 s-1 of ideally 3 or in real terms around 3 (depending on measurement error). If the recycling stream were to move in the direction of a higher Trouton ratio, this would cause a change in processing behavior in the stretch blow-molding process, which is undesirable. ⁸ Härth, M., Dörnhöfer, A.: Film blowing of linear and long-chain branched poly(ethylene terephthalate), Polymers 2020, 12, 1605.⁹ Incarnato L., Scarfato, P., Di Maio, L., Acierno, D.: Structure and rheology of recycled PET modified by reactive extrusion, Polymer 2000, 41, 6825-6831.¹⁰ Dhavalikar R. D.: Reactive melt modification of polyethylene terephthalate; Dissertation, Faculty of New Jersey Institute of Technology, 2003

### Advantages of the Invention

Some desired attributes of an extrusion-blow-molded bottle made of PET are to have the highest possible drop height in the drop test while maintaining a high transparency and glossy appearance of the bottle. Such attributes can be readily achieved with suitable, commercially available vPET types.

For reasons of sustainability and as a result of new legal regulations or voluntary commitments on the part of the industry, there is a need to increase the use of recycled material originating from the post-consumer collection of packaging. When using rPET for extrusion-blow-molded bottles, it is desired that, as far as possible, the same properties are achieved as if the article with the same bottle weight had been produced from vPET using the same blowing mold. In addition, such items produced in this way must themselves be recyclable. In concrete terms, this means that such bottles must be designed to match the existing recycling stream for PET (goal: bottle-to-bottle recycling), which is primarily used for the injection-molding of parisons for stretch blow-molding, without changing the typical processing properties of such material stream.

For this reason, the problem to be solved is the production of an extrusion-blow-molded hollow body made of rPET, which has a drop height in the drop test and a gloss comparable to the drop height and gloss of a hollow body made of vPET.

In addition, the hollow body made of rPET should be rheologically such that it does not cause an undesirable increase in the elastic properties of the parisons used for injection-molding for the purpose of stretch blow-molding bottles made of PET during the recycling downstream of the post-consumer collection of plastic packaging.

### Description with Definitions

Intrinsic viscosity (IV) is measured according to the ASTM 4603-03 standard.

Zero shear viscosity is the limit of shear viscosity of a polymer when the shear rate approaches 0 s⁻¹.

The term “rPET” is understood to mean recycled PET that comes from the collection of post-consumer PET items, in particular PET bottles.

The term “vPET” is understood to mean “virgin” PET, i.e. new PET.

Bottle format is understood as a specific shape of a bottle obtained from a similar mold cavity. If the geometry of the mold cavity is changed, the bottle format will no longer be the same. However, if the bottle weight is changed (typically via a change in the wall thickness of the extruded parison) but is produced with the same kind of mold cavity, the bottle format will still be the same. However, the bottles actually formed will then have a different weight. The designation of the same kind of mold cavity is important, since a plurality of mold cavities of the same kind are typically arranged in parallel in a production mold. In production, the typical goal is that the bottles from all mold cavities in a production mold are as similar as possible (for example, with regard to weight). The drop test is understood to be: the Bruceton staircase drop test according to Procedure B from ASTM D2463. The drop heights achieved from the drop test were determined for bottles of the same bottle format with comparable bottle weight (technically usual and unavoidable variations included, maximum +/−10%, or more advantageously maximum +/−5% related to the nominal weight), wherein the bottles were produced with different materials. The drop heights were related to a reference material (for example, linear vPET 1). The relative drop height is determined as the drop height of the material in question divided by the drop height of the reference material of the same bottle format with comparable weight (see explanations above). The requirement here is the same loading conditions. Free fall onto the bottle base is defined as the loading condition. The bottles are supplied to the drop test in the filled, closed state (with the associated cap).

Parison stiffness is the resistance of the parison extruded on the extrusion blow-molding line to elongation due to gravity. If the parison elongates only a little, the parison stiffness is high. If the parison downright runs away, the parison stiffness is very low. This semi-quantitative parameter is determined by observing the parison during the ejection of the melt into the open air.

Gloss is determined with a 60° gloss meter according to ASTM D523.

The melt-rheological characterization was carried out according to ISO 11443:2014. Samples are dried for 12 h at 120° C. in vacuum. A Göttfert Rheograph 75 with 2×15 mm test channel was used for the test. The capillaries 10/1 and 0/1 mm were used. The test temperature was 275° C. A Bagley correction and a Rabinowitsch-Weissenberg correction were performed. Both the shear viscosity and the extensional viscosity were determined. Using the method according to Cogswell (first description by Cogswell in 1972¹¹), the extensional viscosity was determined from the inlet pressure losses by means of WinRheo II software (Göttfert Werkstoffprüfmaschinen GmbH, Buchen, Germany). Using the shear viscosity data as a function of deformation rate (shear rate), the parameters of the Carreau approach were determined using a statistical adjustment calculation using the least squares method, in order to calculate values between the individual measurement points. ¹¹ Cogswell F. N.: Measuring the extensional rheology of polymer melts, Trans. Soc. Rheol. 1972, 16(3), 383-403; Cogswell F. N.: Converging flow of polymer melts in extrusion dies. Polym. Eng. Sci. 1972, 12, 64-73.

For the purposes of this application, the Trouton ratio is to be understood as defined here: The Trouton ratio was determined by dividing the extensional viscosity according to Cogswell (determination as described in the previous section) determined at a given deformation rate (rate of elongation) by the shear viscosity calculated for the deformation rate in question by means of the Carreau ansatz (determination as described in the previous section). Following the theory, idealized linear polymers have a Trouton ratio of 3. In the static shear range (deformation rate close to zero), this also applies to polymers that exhibit intensive pseudoplastic behavior (so-called “shear thinning”) at higher shear rates. If the Trouton ratio is higher than 3 away from the static shear range (typically >0.1⁻¹), these are signs of structural deviations from the ideal linear polymer chain. This typically occurs with branched polymers. Such deviating behavior is strongly pronounced in the case of highly branched polymers such as low-density polyethylene (PELD). Merten¹² shows this difference in the Trouton ratio outside the low shear range (Merten calls this the Trouton number) for LLDPE and LDPE: LDPE has a much higher Trouton ratio due to the higher degree of branching than LLDPE. ¹² Merten, M: Einfluß der Dehnviskosität auf die Folienextrusion; https://docplayer.org/42120151-Einfluss-der-dehnviskositaet-auf-diefolienextrusion.html; retrieved on Jul. 13, 2021

The comparative or reference condition of a bottle is that obtained with a linear vPET type of certain intrinsic viscosity in relation to the drop height in the drop test and to gloss.

The advantages are achieved with a method for the production of granulate suitable for the production of extrusion-blow-molded hollow bodies by the features indicated in the independent claims. Developments and/or advantageous alternative embodiments form the subject-matter of the dependent claims.

### SUMMARY OF THE INVENTION

The invention is advantageously characterized in that in a step (c) after step (b), PET material from various type-sorted sorting processes according to step (a) is premixed in such a way that the Trouton ratio of the mixed PET material at a shear rate of 50 to 200 s⁻¹ is less than 4. In detailed tests according to the following description, it was found that the Trouton ratio of less than 4 (at a shear rate of 50 to 200 s⁻¹) with mixtures of rPET, from which hollow bodies are produced by extrusion blow-molding, in combination with the correspondingly high intrinsic viscosity, leads to the desired properties: The hollow bodies have a drop height in the drop test and a gloss that are comparable to the drop height and gloss of a hollow body made of vPET.

In a further particularly advantageous embodiment of the invention, the Trouton ratio of the material obtained in step (j) at a shear rate of 50 to 200 s⁻¹ is less than 4. This granulate property is also required in order to obtain extrusion-blow-molded hollow bodies with the properties described above. If the Trouton ratio is too high, this will have a negative effect on the achievable gloss.

It has proven to be expedient if, during the melting according to step (e), only those substances are added which do not cause the Trouton ratio of the material resulting in step (j) at a shear rate of 50 to 200 s⁻¹ to rise above 4. This method step ensures that the plastic granulate produced is of the quality required to produce high-quality hollow bodies with the corresponding drop height and gloss.

Expediently, in step (h), the melt streams are passed through a water bath for cooling and solidification, in order to form a continuous strand and are subsequently separated into pellets by a cutting device. The granulate can be produced quickly and efficiently in a continuous method.

It is advantageous if the melt streams in step (h) are pressed into a water bath and are separated by means of a blade directly at the outlet from the aperture plate to form melt droplets, which solidify in the water bath to form pellets and are flushed away by the flowing water in the water bath and are separated from the water by a separation method. Suitable separation methods are, for example, a hydrocyclone or a screen. This allows pellets of the required size to be produced easily and quickly.

In a further embodiment of the invention, the pellets are crystallized in step (i) by either being introduced into a hot-air crystallizer, where they are treated under continuous agitation by continuous application of heat by introducing hot air at a temperature between 100 and 200° C. with a typical dwell time of 5 to 120 minutes or being crystallized in a crystallizer operating with infrared radiation, wherein the pellets are introduced into a rotating drum, where infrared radiators are placed above the bulk material and the energy input/heat input into the pellets is effected by the released infrared radiation.

Hot-air crystallizers of a design typical in the industry are, for example, Eisbär crystallizers, Piovan CR series, SP Protec SOMOS crystallizers, SB plastics vertical crystallizers CR series, Viscotec cry20, etc. The infrared radiators placed in the drum above the bulk material may be, for example, SB Plastics ITD, Kreyenborg IRD, Kreyenborg IR Batch. The rotating drum serves for the movement of the bulk material (on the one hand for the circulation of the bulk material, such that a uniform heat input into the granulate takes place, along with the conveying of the bulk material in the axial direction of the drum) and analogously to the agitator in the aforementioned container, in order to avoid pellets sticking together during the crystallization process.

Expediently, the pellets are dried to less than 50 ppm residual moisture content, or advantageously less than 30 ppm. Due to this low residual moisture content, the pellets remain free-flowing and easy to process. In addition, they are stable for a long time without losing their original quality.

A further aspect of the invention also relates to the production of a hollow body from the granulate described above. For this reason, the invention is also advantageously characterized by the hollow body passing a drop test (Bruceton staircase drop test according to Procedure B from ASTM D2463) from at least the same height as an identically constructed hollow body made of a linear vPET having the same intrinsic viscosity of 1.0 to 1.7 dl/g (measured according to ASTM D4603). This property is due to the intrinsic viscosity. However, this does not ensure that the hollow body has the desired gloss.

It has proven to be advantageous if the hollow body passes the drop test from a height that corresponds to at least 80%, more advantageously at least 90% and even more advantageously at least 95% of the height that an identically constructed hollow body made of a linear vPET with the same intrinsic viscosity of 1.0 to 1.7 dl/g (measured according to ASTM D4603) reaches in a drop test. Deviations from the drop height of up to 20% from the reference hollow body are acceptable, since the hollow body made of rPET is still sufficiently robust.

It also has proven to be advantageous if the hollow body has a gloss (determined with a 60° gloss meter according to ASTM D523) like an identically constructed hollow body made of a linear vPET with the same intrinsic viscosity of 1.0 to 1.7 dl/g (measured according to ASTM D4603). Gloss can be determined with a 60° gloss meter according to ASTM D523. As a result, the appearance of the hollow body is indistinguishable from that of a hollow body made of a linear vPET granulate, leading to significantly higher consumer acceptance of the hollow body. This property as regards gloss is due to the compliance with the Trouton ratio of less than 4 of the rPET granulate.

It has proven to be advantageous if the hollow body has at least 70%, at least 80% or at least 90% of the gloss as an identically constructed hollow body made of a linear vPET having the same intrinsic viscosity of 1.0 to 1.7 dl/g (measured according to ASTM D4603). Gloss deviations of up to 20% from the reference hollow body are acceptable, since the hollow body made of rPET still has sufficient consumer acceptance.

It has proven to be advantageous if the dried pellets are melted on an extrusion blow-molding line by means of a single-screw extruder with admixture of 0 to 60% crystallized and dried ground material from production waste that accrues during extrusion blow-molding and 0 to 10% admixture of a concentrate, which contains colorants and/or or technically customary functional auxiliaries, in order to form a melt. The production waste may be so-called flash, which is ground by means of a mill. The colorants can be dyes and/or pigments, and the functional auxiliaries can be additives such as UV absorbers, lubricants, antistatic agents, etc. For this reason, the rPET pellets may be processed on an extrusion blow-molding line customary in the industry.

Expediently, the melt obtained is fed to a melt distributor for forming the melt strands into parisons, in order to divide them into the corresponding number of parisons corresponding to the number of mold cavities present in a blowing mold. This can increase the effectiveness of the production line.

In an advantageous way, the parisons obtained will be formed in a suitable blowing mold into hollow bodies with or without a handle, which have a volume of 25 ml to 25 l. As a result, hollow bodies customary in the industry with a surprisingly high drop height after the drop test and a high gloss can be obtained from the rPET granulate.

Mechanical removal of the protrusions formed on the hollow body during the blowing process means that the shape of the hollow body can still be machined after inflation. Protrusions are not part of the hollow body and can be removed in the region of the bottle shoulder, the bottle base and in the region of the handle.

A further aspect of the invention relates to a method by which the hollow bodies described above are mixed together with stretch-blow-molded PET bottles to form a mixture that is processed into pellets, which pellets in turn can be used to produce parisons (preforms) for the stretch blow-molding method.

A further aspect of the invention relates to hollow bodies that are produced from the granulate described above. Research into the Trouton ratio leads to the finding that hollow bodies can be produced with a height in the drop test and with a gloss that are comparable to these parameters of hollow bodies produced from vPET granulate of the same intrinsic viscosity as the granulate described above. For this purpose, the Trouton ratio of the mixed PET material at a shear rate of 50 to 200 s⁻¹ must be less than 4.

Further advantages and features of the invention are apparent from the following description of several experimental examples:

Extrusion-blow-molded bottles were produced on a pilot line in a blowing mold with a mold cavity. The ejection of the parison was continuous. This pilot line is representative of a production line with a plurality of mold cavities connected in parallel, which allow the parisons extruded in parallel to be formed simultaneously into a number of bottles equal to the number of parisons. Pilot molds were available for bottles with 1 l, 2.7 l and 5 l nominal volume. The vPET types 1 to 3 are commercially available EBM PET types from various manufacturers. The reference material vPET 1 is a commercially available vPET that is marketed for use in the extrusion blow-molding of bottles with a handle in the range of 1 l or larger. The vPET 4 material used for comparison purposes was obtained by solid-phase polycondensation of an injection-molded PET with IV 0.8 dl/g. The vPET 5 is a commercially available PET type for the injection-molding of parisons with IV 0.81 dl/g. The rPET types 1, 2 and 4 were produced analogously to the method in the Swiss patent request with the application number 00304/20. The rPET type 1 contained 0.083% PMDA and was solid-phase polycondensed for 10 h, the rPET type 2 contained 0.099% PMDA, and was solid-phase polycondensed for 11 h. The rPET type 4 contained 0.105% PMDA and was solid-phase polycondensed for 10 h. The rPET type 3 was prepared according to steps (a) to (j), with no substances being admixed in method step (e). The method steps (a) to (j) for the production of rPET type 3 are as follows:
(a) the PET articles originating from the post-consumer collection of plastic packaging, in particular PET bottles separated by source (region of origin and product category of the filling material) and color are sorted by type, washed and comminuted,
(b) contaminants such as metal or paper are removed before, at the same time or after method step (a),
(c) the comminuted PET material from various sources is premixed in such a way that its Trouton ratio and that of the material obtained thereby in step (j) at a shear rate of between 50 and 200 s⁻¹ is less than 4 (this means that batches whose Trouton ratio in the specified range of shear rate is 4 or greater cannot be used for these purposes),
(d) the comminuted, premixed PET material is then dried,
(e) the comminuted, premixed PET material is then melted, and in this step only those substances are added which do not cause the Trouton ratio of the material resulting in step (j) to rise above 4 (at a shear rate of between 50 and 200 s⁻¹),
(f) the comminuted, premixed, melted PET material is then pressed through a melt filter,
(g) the filtered melt is passed via an aperture plate with many outlet openings, in order to divide it into individual melt streams; and
(h) these melt streams are passed through a water bath for solidification and cooling, forming a quasi-endless strand, and are then separated into pellets by a cutting device. Alternatively, these melt streams are pressed into a water bath and separated into melt droplets by a blade directly at the outlet from the aperture plate. The melt droplets are solidified into pellets in the water bath, flushed away by the flowing water and separated from the water by a suitable method (for example, hydrocyclone, screen).

The pellets obtained in this way have an intrinsic viscosity of 0.5 to 0.75 dl/g.

In method steps (i) to (j), the pellets obtained are further processed:
(i) the pellets thus obtained are crystallized and
(j) the crystallized pellets are dried and condensed in a solid-phase polycondensation reactor until they reach an intrinsic viscosity of 1.0 to 1.7 dl/g.

By means of the following method steps (k) to (o), a hollow body is extrusion-blow-molded from the pellets:
(k) the pellets thus obtained are dried to less than 50 ppm residual moisture content, or more advantageously less than 30 ppm.
(l) the dried pellets are melted on an extrusion blow-molding line by means of a single-screw extruder with admixture of 0 to 60% crystallized and dried ground material of production waste, that usually accrues during extrusion blow-molding as a result of the process (so-called flash, which is ground by means of a mill), and 0 to 10% admixture of a concentrate, which contains colorants (dyes and/or pigments) and/or technically customary functional auxiliaries (additives such as UV absorbers, lubricants, antistatic agents, etc.), in order to form a melt
(m) the melt thus obtained is fed to a melt distributor followed by an apparatus for forming the melt strands into parisons, in order to divide them into the number of parisons corresponding to the number of mold cavities present in the blowing mold,
(n) the parisons thus obtained are formed in a suitable blowing mold into hollow bodies with or without a handle, having a volume of 25 ml to 25 l,
(o) the protrusions on the bottle shoulder, base and, if necessary, in the region of the handle, which are not part of the hollow body, are removed by machine.

This production method, which maintains the Trouton ratio in steps (c) and (e), can produce a hollow body with the following properties:
The hollow body has a relative drop height similar to that of the same hollow body when made made (at comparable weight) from a linear vPET having the same intrinsic viscosity of 1.0 to 1.7 dl/g (measured according to ASTM D4603), wherein the relative drop height of the linear vPET is set at 100% and is hereinafter referred to as reference dimension 1
The hollow body exhibits, at comparable weight, a relative gloss such as that exhibited by the same hollow body when made of a linear vPET having intrinsic viscosity of 1.0 to 1.7 dl/g (measured according to ASTM D4603), wherein the relative gloss of the linear vPET is set to be 100% and is hereinafter referred to as reference dimension 2
The hollow body can after use be fed to the post-consumer collection of plastic packaging and can be admixed in a quantity of up to 50% to stretch-blow-molded PET bottles, which also come from post-consumer collection. The mixture can be prepared again into pellets by the usual technical processing methods according to method steps (a) to (j). However, with the deviating target of an IV in step (j) of 0.75 to 0.9 dl/g, making the pellets suitable for the production of parisons by means of injection-molding for stretch blow-molding.

Crystallization according to method step (i) can be carried out as follows: Crystallization is carried out according to standard industrial procedures by either inserting such pellets into a hot-air crystallizer of typical industrial design (such as Eisbär crystallizer, Piovan CR series, SP Protec SOMOS crystallizers, SB plastics vertical crystallizer CR series, Viscotec Cry20, etc.) and treated there under continuous stirring by continuous application of heat by introducing hot air at a temperature between 100 and 200° C. with a typical dwell time of 5 to 120 minutes, or crystallized in a crystallizer customary in the industry operating with infrared radiation, wherein the granulate is introduced into a rotating drum, where infrared radiators are placed above the bulk material (such as, for example, SB Plastics ITD, Kreyenborg IRD, Kreyenborg IR Batch) and the energy input/heat input into the granulate is effected via the released infrared radiation. Here, the rotating drum serves for the movement of the bulk material (on the one hand for the circulation of the bulk material, such that a uniform heat input into the granulate takes place, along with the conveying of the bulk material in the axial direction of the drum) and analogously to the agitator in the aforementioned container, in order to prevent the pellets sticking together during the crystallization process. Crystallization of the pellets prevents sticking or agglomeration of the granulate in the subsequent method steps. In technically common production lines, the crystallizer can be part of a common recycling line (for example, Viscotec recoSTAR).

Other possible pelletization methods in addition to the pelletization methods according to step (h) are:
Pelletization in a water ring granulator:
   The melt exiting through the holes of the heated pelletizing aperture plate (1) is knocked off by rotating knives (2). The pellets are thrown outward into a rotating water ring (3) by centrifugal force. This cools the pellets and transports them via a flexible discharge channel to the granulate dewatering screen, where the pellets are separated from the cooling water (4). After oversize separation, the granulate passes to the drying centrifuge. By means of air flow, it is conveyed onward to the silo or to the bagging station via a transport line. The cooling water is recirculated to the pelletizing head via a cooling water filtration device and a heat exchanger by means of a water pump.
Hot-cut pelletizing systems with air technology:
   Functioning as with underwater pelletization (h), except that air is used as the heat transfer medium or fluid.

The melt is pressed through an aperture plate,
the hot-cut is effected by knives,
the pellets are washed away by the air,
and separation of the pellets from the air is carried out.
Partial underwater strand pelletizing system:
   Functioning as with the cold-cut pelletizing method, except that a water spray is used for cooling instead of a water bath.

The melt is discharged from the aperture plate (a plurality of holes) into a strand cooling trough.

The strand cooling trough is covered with a flowing film of water; there are also spray heads (shower heads) that apply water. This is followed by pelletization in the strand pelletizer. Dewatering (for example, a screen) and post-drying (for example, a centrifuge) then takes place or the pellets go straight to a centrifuge for dewatering and drying.

In the case of drying after underwater pelletization, the drying centrifuge should generally be mentioned, in addition to the hydrocyclone. With methods in which water is used, a screen is usually inserted after the pelletizer for coarse dewatering or separation. After this, post-drying (for example, by means of a centrifuge) is common.

Of the materials produced, the intrinsic viscosity of the granulate was determined. Table 1 summarizes the results of a sampling with a 5 l bottle with a handle. It can be seen that vPET types 1 to 3 have an IV of 1.30 to 1.41 dl/g and a Trouton ratio of approximately 3, and gave comparable relative drop heights in the drop test, and that the measured gloss was approximately the same. The vPET 4, also with a Trouton ratio of 3, showed a parison strength that was too low to enable the same bottle be formed. Surprisingly, the type rPET1 showed high parison stiffness at an IV of only 0.96 dl/g, but only 53% of relative drop height and only 86% of gloss compared to vPET1. The Trouton ratio of clearly above 3 observed for rPET 1 suggests that this type has greater elasticity than types vPET 1 to 4, and therefore must exhibit branching and hence affects the high parison stiffness. Apart from the fact that the rPET 1 does not achieve the same results in the drop test and in gloss as types vPET 1 to 3, bottles made of rPET 1 should not be further processed after use into material for injection-molding parisons. This is because an atypical material input stream for this application during recycling inevitably leads to atypical processing behavior in the stretch blow-molding process. The vPET5 with IV 0.81 dl/g had a parison stiffness that was much too low. Table 2 shows results of tests with a 2.7 l bottle with a handle. The linear PET types (vPET 1 and rPET 3) exhibit higher relative drop test and gloss than the two branched types (rPET 1 and rPET 2). It was further shown that there are also limits to the modification of PET by means of branching. The bottles made of branched rPET 1 and branched rPET 2 from the example in Table 2 showed a less clear appearance when viewed by an individual; in general, the surface appeared less glossy compared to the linear vPET 1 and linear rPET 3. This can be verified on the basis of the measured gloss. This observation is made analogously by Härth and Dörnhöfer 2020¹³ for a blown film, where the use of a branching additive causes a strong turbidity of the blown film.

TABLE 1
Results of the tests with a 5 l bottle with a handle (Example 1)

| | | | | Drop test | Gloss |
|---|---|---|---|---|---|
| | | | | (relative) | (relative) |
| | IV | Trouton | Parison | to linear | to linear |
| | [dl/g] | ratio[−] | stiffness | vPET 1 | vPET 1 |
| vPET 1 | 1.32 | 2.9 (73 s⁻¹) | High | 100% | 100% |
| | | 3.3 (157 s⁻¹) | | (reference) | (reference) |
| vPET 2 | 1.30 | 3.0 (71 s⁻¹) | High | 96% | 99% |
| | | 3.3 (157 s⁻¹) | | | |
| vPET 3 | 1.41 | 2.9 (72 s⁻¹) | High | 105% | 100% |
| | | 3.4 (153 s⁻¹) | | | |
| vPET 4 | 1.16 | 3.0 (75 s⁻¹) | Low | — | — |
| | | 3.0 (174 s⁻¹) | | | |
| rPET 1 | 0.96 | 4.3 (58 s⁻¹) | High | 53% | 86% |
| | | 5.5 (123 s⁻¹) | | | |
| vPET 5 | 0.81 | 2.7 (84 s⁻¹) | Very low | — | — |
| | | 2.5 (208 s⁻¹) | | | |

¹³ Härth, M., Dörnhöfer, A.: Film blowing of linear and long-chain branched poly(ethylene terephthalate), Polymers 2020, 12, 1605.

TABLE 2
Results of tests with a 2.7 l bottle with a handle (Example 2)

| | | | | Drop test | Gloss |
|---|---|---|---|---|---|
| | | | | (relative) | (relative) |
| | IV | Trouton | Parison | to linear | to linear |
| | [dl/g] | ratio[−] | stiffness | vPET 1 | vPET 1 |
| vPET 1 | 1.32 | 2.9 (73 s⁻¹) | High | 100% | 100% |
| | | 3.3 (157 s⁻¹) | | (reference) | (reference) |
| rPET 1 | 0.96 | 4.3 (58 s⁻¹) | High | 57% | 81% |
| | | 5.5 (123 s⁻¹) | | | |
| rPET 2 | 1.02 | 5.1 (51 s⁻¹) | Very high | 56% | 66% |
| | | 7.0 (103 s⁻¹) | | | |
| rPET 3 | 1.17 | 3.3 (68 s⁻¹) | High | 120% * | 92% |
| | | 3.7 (152 s⁻¹) | | | |

* In retrospect, this turned out to be an outlier.

Table 3 shows supplementary test results for the 2.7 l bottle with a handle, for which results have already been presented in Table 2. It now appears that the relative drop test of rPET 3 compared to vPET 1 is somewhat where it should be on the basis of the intrinsic viscosity.

TABLE 3
Results of tests with a 2.7 l bottle with a handle (Example 3)

| | | | Drop test |
|---|---|---|---|
| | IV | Parison | (relative) to |
| | [dl/g] | stiffness | linear vPET 1 |
| vPET 1 | 1.32 | High | 100% reference |
| rPET 3 | 1.15 | High | 82% |

Following this, a 1 l bottle with a handle was taken as a sample. Its results are shown in Table 4. The relative drop height of rPET 1 and rPET 4 relative to rPET 3 is approximately where one would expect on the basis of the intrinsic viscosity. For this reason, for illustrative purposes, the relative drop height was calculated in relation to vPET 1 by referencing the relative drop height reached by each material in Table 4 with the result for rPET 3 from Table 3.

TABLE 4
Results of tests with a 1 I bottle with a handle (Example 4)

| | | | | | | Drop test | |
|---|---|---|---|---|---|---|---|
| | | | | | Drop test | (relative) to | Gloss |
| | IV | Trouton | | Parison | (relative) | vPET 1 | (relative) |
| | [dl/g] | ratio[−] | | stiffness | to rPET 3 | (calculated) | to rPET 3 |
| rPET 3 | 1.15 | 3.3 | (68 s⁻¹) | High | 100% | 82% | 100% |
| | | 3.7 | (152 s⁻¹) | | | | |
| rPET 1 | 0.96 | 4.3 | (58 s⁻¹) | High | 77% | 63% | 87% |
| | | 5.5 | (123 s⁻¹) | | | | |
| rPET 4 | 0.96 | 4.2 | (58 s⁻¹) | High | 76% | 63% | 83% |
| | | 5.4 | (125 s⁻¹) | | | | |

It can thus be seen that rPET types 1, 2 and 4 did not meet the requirements placed on them. Although they show a high parison stiffness, which makes them suitable for molding the bottles with a handle described earlier, the obtained performance characteristics with respect to the relative drop test and relative gloss are much worse in relation to rPET 3 and relevant vPET types. Moreover, only the rPET 3 is not expected to affect the PET recycling stream in a negative way, since its Trouton ratio is below 4 between 50 and 200 s-1. Negative influence is expected for rPET 1, 2 and 4 due to their Trouton ratios above 4.

The tests show that the hollow bodies made of rPET 3 achieve a relative drop height of at least 80%, of at least 90% or of at least 95% of the relative drop height of the vPET (in particular vPET 1; reference dimension 1). The tests also show that the hollow bodies made of rPET 3 achieve a relative gloss of at least 70%, of at least 80% or of at least 90% of the relative gloss of the linear vPET (in particular vPET 1; reference dimension 2).

1. Method of producing a plastic granulate suitable for the production of extrusion-blow-molded hollow bodies, comprising:
sorting by type, washing, and comminuting PET articles originating from a post-consumer collection of plastic packaging to form a PET material,
removing contaminants, before, at the same time or after the sorting,
premixing the PET material from various types of the sorted PET articles so that a Trouton ratio of PET material at a shear rate of 50 to 200 s⁻¹ is less than 4,
drying the premixed PET material,
melting the dried PET material,
pressing the melted PET material through a melt filter,
dividing the filtered PET material into a plurality of individual melt streams,
cooling and solidifying the plurality of melt streams in a water bath,
separating the solidified melt flows into pellets, wherein the pellets thus obtained have an intrinsic viscosity of 0.5 to 0.75 dl/g,
crystallizing the pellets, and
drying and condensing the crystallized pellets in a solid-phase polycondensation reactor until they reach an intrinsic viscosity of 1.0 to 1.7 dl/g.

2. Method according to claim 1, wherein the Trouton ratio of the crystallized pellets at a shear rate of 50 to 200 s⁻¹ is less than 4.

3. Method according to claim 2, wherein during the melting any substances added that do not cause the Trouton ratio of the crystallized pellets at a shear rate of 50 to 200 s⁻¹ to rise above 4.

4. Method according to claim 1, further comprising passing the plurality of melt streams through a water bath for the cooling and solidification, to form to form a plurality of continuous, and cutting the plurality of continuous strands into pellets.

5. Method according to claim 1 further comprising, pressing the plurality of melt streams into a water bath and cutting the plurality of melt streams with a blade directly at an outlet of an aperture plate to form melt droplets, which melt droplets solidify in the water bath to form the crystalline pellets that are flushed away by flowing water in the water bath and are subsequently separated from the water.

6. Method according to claim 1 further comprising, crystallizing the pellets by introduction into a hot-air crystallizer, where the pellets are treated with continuous agitation by a continuous application of heat by introducing hot air at a temperature between 100 and 200° C. with a typical dwell time of 5 to 120 minutes or by being crystallized in a crystallizer operating with infrared radiation, wherein the pellets are introduced into a rotating drum, wherein infrared radiators are placed above the bulk material and wherein an energy input/heat input into the pellets is affected by a released infrared radiation.

7. Method according to claim 1, wherein the pellets are dried to less than 50 ppm residual moisture content.

8. A method of using a PET granulate for production of an extrusion-blow-molded hollow body, comprising:
sorting by type, washing, and comminuting PET articles originating from a post-consumer collection of plastic packaging to form a PET material,
removing contaminants, before, at the same time or after sorting,
premixing the PET material from various types of the sorted PET articles so that a Trouton ratio of mixed PET material at a shear rate of 50 to 200 s⁻¹ is less than 4,
drying the premixed PET material,
melting the dried PET material,
pressing the melted PET material through a melt filter,
dividing the filtered PET material into a plurality of melt streams,
cooling and solidifying the plurality of melt streams in a water bath,
separating the solidified melt flows into pellets, wherein the pellets have an intrinsic viscosity of 0.5 to 0.75 dl/g,
crystallizing the pellets, and
drying and condensing the crystallized pellets in a solid-phase polycondensation reactor until they reach an intrinsic viscosity of 1.0 to 1.7 dl/g, and
forming an extrusion-blow-molded hollow body from the dried and condensed crystallized pellets, wherein the hollow body passes a drop test (Bruceton staircase drop test according to procedure B from ASTM D2463) from at least a same height as an identically constructed hollow body made of a linear vPET having an intrinsic viscosity of 1.0 to 1.7 dl/g (measured according to ASTM D4603).

9. to the method of claim 8, wherein the hollow body passes the drop test from the height that corresponds to at least 80% of the same height that the identically constructed hollow body made of a linear vPET having the same intrinsic viscosity of 1.0 to 1.7 dl/g (measured according to ASTM D4603) reaches in the drop test.

10. that the method of claim 8, wherein the hollow body has a gloss similar to the identically constructed hollow body made of a linear vPET having the same intrinsic viscosity of 1.0 to 1.7 dl/g (measured according to ASTM D4603).

11. that the The method of claim 10, wherein the hollow body has at least 70% of the gloss as an identically constructed hollow body made of a linear vPET having the same intrinsic viscosity of 1.0 to 1.7 dl/g (measured according to ASTM D4603).

12. that the The method of claim 8, wherein the dried and condensed pellets are melted on an extrusion blow-molding line by a single-screw extruder with admixture of 0 to 60% of crystallized and dried ground material comprised of production waste that accrues during extrusion blow-molding and 0 to 10% admixture of a concentrate, which contains colorants and/or technically customary functional auxiliaries, in order to form a melt.

13. that the The method of claim 12, wherein the melt obtained is fed to a melt distributor for forming the plurality of melt strands into parisons, in order to divide them into a corresponding number of parisons corresponding to a number of mold cavities present in a blowing mold.

14. that the The method of claim 13, wherein the parisons obtained are formed in a suitable blowing mold into hollow bodies with or without a handle, which have a volume of 25 ml to 25 l.

15. The method of claim 8, further comprising removing protrusions formed on the hollow body during the blowing process by machine.

16. Method for the production of granulate suitable for the production of parisons by injection-molding for stretch blow-molding, comprising:
admixing a post consumer collection of hollow bodies formed from PET pellets having an intrinsic viscosity of 1.0 to 1.7 dl/g (measured according to ASTM D4603), plastic packaging, and stretch-blow-molded PET bottles in a proportion of a maximum of 50%, wherein the mixing is carried out according to the following method steps:
sorting by type, washing, and comminuting of PET articles originating from the post-consumer collection of plastic packaging to form a PET material,
removing contaminants, before, at the same time or after the sorting,
drying the PET material,
melting the dried PET material,
pressing the melted PET material through a melt filter,
dividing the filtered PET material into individual melt streams,
cooling and solidifying the melt streams in a water bath; and
separating the solidified melt streams into pellets, wherein the pellets thus obtained have an intrinsic viscosity of 0.75 to 0.9 dl/g.

17. A hollow body produced from a PET granulate formed by a method, comprising:
sorting by type, washing, and comminuting PET articles originating from a post-consumer collection of plastic packaging to form a PET material,
removing contaminants, before, at the same time or after sorting,
premixing the PET material from various types of the sorted PET articles so that a Trouton ratio of mixed PET material at a shear rate of 50 to 200 s⁻¹ is less than 4,
drying the premixed PET material,
melting the dried PET material,
pressing the melted PET material through a melt filter,
dividing the filtered PET material into a plurality of melt streams,
cooling and solidifying the plurality of melt streams in a water bath,
separating the solidified melt flows into pellets, wherein the pellets have an intrinsic viscosity of 0.5 to 0.75 dl/g,
crystallizing the pellets, and
drying and condensing the crystallized pellets in a solid-phase polycondensation reactor until they reach an intrinsic viscosity of 1.0 to 1.7 dl/g, and
forming a hollow body from the dried and condensed crystallized pellets, wherein the hollow body passes a drop test (Bruceton staircase drop test according to procedure B from ASTM D2463) from at least a same height as an identically constructed hollow body made of a linear vPET having an intrinsic viscosity of 1.0 to 1.7 dl/g (measured according to ASTM D4603).
